(19) United States
(12) Patent Application Publication
(10) Pub. No.: US 2024/0004199 A1
(43) Pub. Date: Jan. 4, 2024

(54) PARTIALLY CURVED LIGHTGUIDE WITH PUPIL REPLICATORS

(71) Applicant: GOOGLE LLC, Mountain View, CA (US)

(72) Inventors: Eliezer Glik, San Diego, CA (US); Oscar Alberto Martinez, San Diego, CA (US); Ozan Cakmakci, San Mateo, CA (US)

(21) Appl. No.: 18/209,723

(22) Filed: Jun. 14, 2023

Related U.S. Application Data
(60) Provisional application No. 63/357,722, filed on Jul. 1, 2022.

(51) Int. Cl. G02B 27/01

(52) U.S. Cl. CPC G02B 27/0172

(57) ABSTRACT

Techniques for implementing a partially curved lightguide with pupil replicators are disclosed. A partially curved lightguide includes an embedded collimator with surfaces that act to collimate light for display prior to the light encountering a surface in a pupil expansion region of an exit pupil expander. By collimating the light within the lightguide rather than collimating the light prior to entering the lightguide, the requisite volume of a form factor of an AR display is minimized by eliminating select collimating optics and thus enabling a less bulky volume of the AR display in the region of the light source. Using techniques disclosed herein, a partially curved lightguide with pupil replicators is achievable in an eyewear display system having a form factor similar to traditional eyeglasses and curved, thin lenses.

### BACKGROUND

The present disclosure relates generally to a wearable eyewear display. In an eyewear display, light from an image source is coupled into a light guide substrate, often referred to as a lightguide or waveguide, by an input optical coupling such as an in-coupling grating (i.e., an “incoupler”), which can be formed on a surface, or multiple surfaces, of the substrate or disposed within the substrate. Once the light beams have been coupled into the lightguide, the light beams are “guided” through the substrate, typically by multiple instances of total internal reflection (TIR), to then be directed out of the lightguide by an output optical coupling (i.e., an “outcoupler”), which can also take the form of an optical grating. The light beams projected from the lightguide overlap at an eye relief distance from the lightguide, forming an exit pupil within which a virtual image generated by the image source can be viewed by the user of the eyewear display.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example display system having a support structure that houses a projection system configured to project images toward the eye of a user, in accordance with some embodiments.

FIG. 2 shows a block diagram of a projection system that projects light representing images onto the eye of a user via a display system, such as the display system of FIG. 1, in accordance with some embodiments.

FIG. 3 shows an example of light propagation within a lightguide of a projection system, such as the projection system of FIG. 2, in accordance with some embodiments.

FIG. 4 shows an example of a portion of a display system with a limited field of view (FOV) in accordance with some embodiments.

FIG. 5 shows an example of a display system with a larger FOV with the incoupler (IC) located in the temple arm in accordance with some embodiments.

FIG. 6 shows an example of a display system with a larger FOV with the IC located in the nose bridge in accordance with some embodiments.

FIG. 7 shows an example of a curved lens display system.

FIG. 8 shows an example of a flat lens display system.

FIG. 9 shows an example of a display system including an embedded collimator with discontinuous surfaces in accordance with some embodiments.

FIG. 10 shows an example of a display system including an embedded collimator with discontinuous surfaces in accordance with some embodiments.

FIG. 11 shows an example of a display system including an embedded collimator with continuous surfaces in accordance with some embodiments.

FIG. 12 shows an example method of manufacturing a collimation region for an eyewear display system in accordance with some embodiments.

### DETAILED DESCRIPTION

In eyewear display systems, typical ophthalmic lens sizes are normally only able to allow for an augmented reality (AR) or mixed reality (MR) display with a small eyebox (herein, the range of different user eye positions that will be able to see the display is referred to as the eyebox of the display), which restricts variance in eye location for viewing the AR or MR display. In order to increase the size of the eyebox, an eyewear display system typically requires relatively thick substrates. However, an ophthalmic lens is generally restricted by its dimensions to accommodate a larger AR or MR eyebox. Using a partially curved lightguide with pupil replicators is one technique to achieve a larger effective eyebox while still fitting within a relatively thin form factor. In this description, the term “pupil” refers to the virtual image of an aperture associated with mirrors, prisms, lenses, or their combinations. The virtual image of a physical aperture as seen through the front of a lens system is known as an entrance pupil. The corresponding image of the aperture as seen through the back of the lens system is known as the exit pupil. Expansion or replication of the pupil in a device refers to expansion or replication of the exit pupil, which typically provides for a larger eyebox and can therefore enable a wider cross-section of individuals to use a single device. Expansion of the exit pupil is typically performed by replication of the entrance pupil so that a single light ray received into the entrance pupil is split into a plurality of parallel light rays distributed along the direction of expansion of the exit pupil.

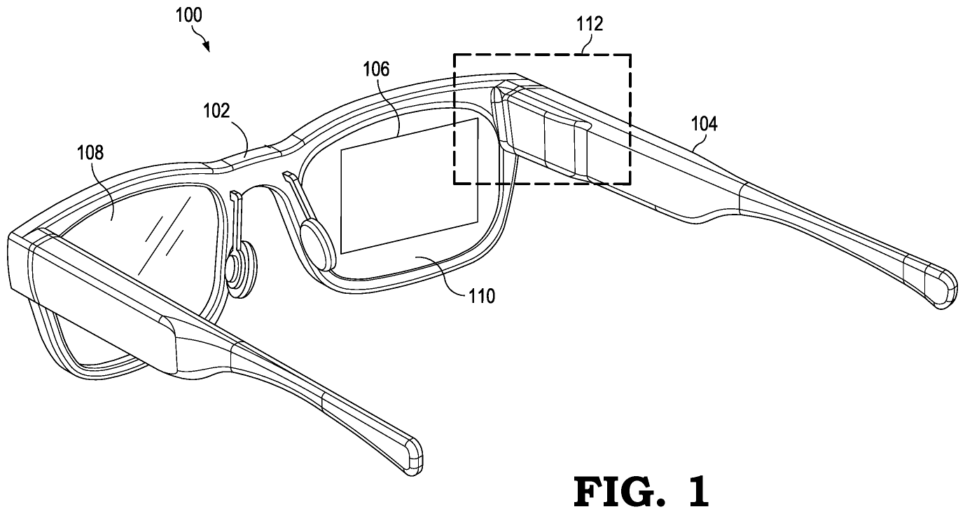

FIGS. 1-12 illustrate various techniques for implementing a partially curved lightguide with pupil replicators. In some embodiments, the partially curved lightguide includes an embedded collimator with continuous or discontinuous surfaces, which act to collimate light for display prior to the light encountering a surface in a pupil expansion region of an exit pupil expander. By collimating the light within the lightguide rather than collimating the light prior to entering the lightguide, as is often the case in conventional AR lenses, the requisite volume of a form factor of an AR display is minimized by eliminating select collimating optics and thus enabling a less bulky volume of the AR display in the region of the light source (e.g., the nose bridge or the temple of an eyeglasses form factor, or another portion of an AR display). Additionally, by combining a curved lightguide with a flat pupil replication region, a relatively thin, curved lens with AR functionality is achievable in part due to the flat pupil replication region having a relatively smaller size than conventional AR lens pupil replication regions, which is possible because the light entering the pupil replication region is collimated closely to the pupil replication region. Accordingly, using techniques disclosed herein, a partially curved lightguide with pupil replicators is achievable in an eyewear display system having a form factor similar to traditional eyeglasses and curved, relatively thin lenses.

FIG. 1 illustrates an example display system 100 that, in some embodiments, implements partially curved lightguide with pupil replicators, having a support structure 102 that includes an arm 104, which houses a projection system configured to project images toward the eye of a user, such that the user perceives the projected images as being displayed in a field of view (FOV) area 106 of a display at one or both of lens elements 108, 110. In the depicted embodiment, the display system 100 is a wearable eyewear display that includes a support structure 102 configured to be worn on the head of a user and has a general shape and appearance of an eyeglasses frame. The support structure 102 contains or otherwise includes various components to facilitate the projection of such images toward the eye of the user, such as a laser projector, an optical scanner, and a lightguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. In other embodiments, region 112 is alternatively or additionally included in the nose bridge of support structure 102. It should be noted that while an example form factor is depicted, it will be appreciated that in other embodiments the display system 100 will have a different shape and appearance from the eyeglasses frame depicted in FIG. 1.

One or both of the lens elements 108, 110 are used by the display system 100 to provide an AR or MR display, in which rendered graphical content can be superimposed over or otherwise provided in conjunction with a real-world view as perceived by the user through the lens elements 108, 110. For example, laser light used to form a perceptible image or series of images are projected by a projector of the display system 100 onto the eye of the user via a series of optical elements, such as a lightguide formed at least partially in the corresponding lens element, one or more scan mirrors, and one or more optical relays. One or both of the lens elements 108, 110 thus include at least a portion of a lightguide that routes display light received by an incoupler, or multiple incouplers, of the lightguide to an outcoupler of the lightguide, which outputs the display light toward an eye of a user of the display system 100. The display light is modulated and projected onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

In some embodiments, the projector is a matrix-based projector, a scanning laser projector, a micro-LED display, or any combination of a modulative light source such as a laser or one or more LEDs and a dynamic reflector mechanism such as one or more dynamic scanners or digital light processors. Generally, the projector can be implemented using any desired light projection component capable of producing display light. In some embodiments, the projector includes multiple laser diodes (e.g., a red laser diode, a green laser diode, and/or a blue laser diode) and at least one scan mirror (e.g., two one-dimensional scan mirrors, which is a micro-electromechanical system (MEMS)-based or piezo-based), for example. The projector is communicatively coupled to the controller and a non-transitory processor-readable storage medium or memory storing processor-executable instructions and other data that, when executed by the controller, cause the controller to control the operation of the projector.

In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. In some embodiments, the projector routes light via first and second scan mirrors, an optical relay disposed between the first and second scan mirrors, and a lightguide disposed at the output of the second scan mirror. In some embodiments, at least a portion of an outcoupler of the lightguide overlaps the FOV area 106.

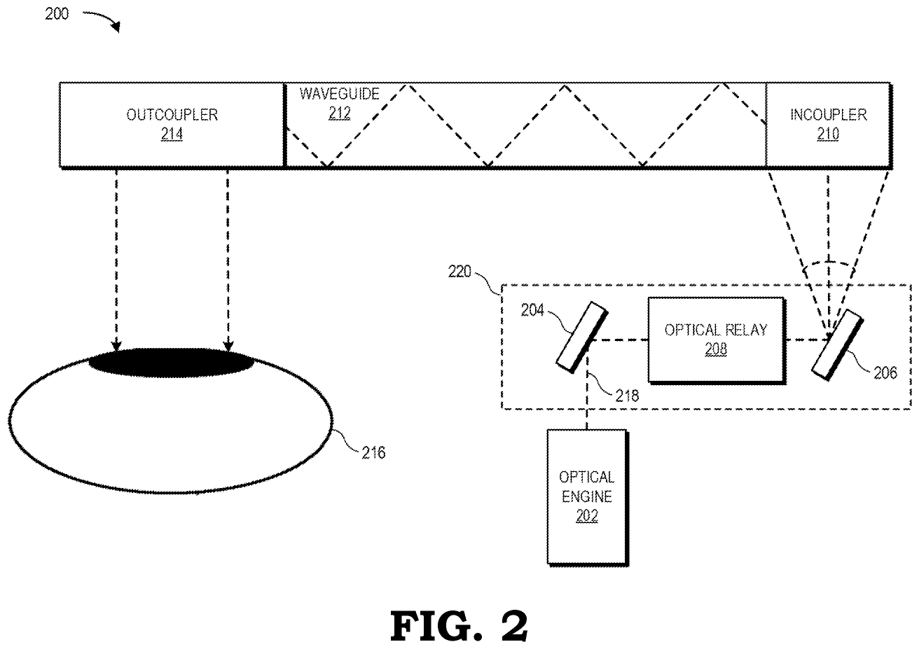

FIG. 2 illustrates a block diagram of a projection system 200 that projects light representing images onto the eye 216 of a user via a lightguide, such as that illustrated in FIG. 1. The projection system 200 includes an optical engine 202, an optional optical scanner 220, and a lightguide 212. In some embodiments, the projection system 200 is implemented in a wearable heads-up display or other display systems.

The optical engine 202 includes one or more light sources configured to generate and output light (e.g., micro-LED display light, visible laser light such as red, blue, and green laser light, and/or non-visible light such as infrared laser light). In some embodiments, the optical engine 202 is coupled to a controller or driver (not shown), which controls the timing of emission of light from the light sources of the optical engine 202 (e.g., in accordance with instructions received by the controller or driver from a computer processor coupled thereto) to produce the light 218 to be perceived as images when output to the retina of the eye 216 of the user.

In some embodiments, the optical scanner 220 includes a first scan mirror 204, a second scan mirror 206, and an optical relay 208. One or both of the scan mirrors 204 and 206 are MEMS mirrors, in some embodiments. For example, the scan mirror 204 and the scan mirror 206 are MEMS mirrors that are driven by respective actuation voltages to oscillate during active operation of the laser projection system 200, causing the scan mirrors 204 and 206 to scan the light 218. Oscillation of the scan mirror 204 causes light 218 output by the optical engine 202 to be scanned through the optical relay 208 and across a surface of the second scan mirror 206. The second scan mirror 206 scans the light 218 received from the scan mirror 204 toward an incoupler 210 of the lightguide 212. In some embodiments, the scan mirror 204 oscillates along a first scanning axis, such that the light 218 is scanned in only one dimension (i.e., in a line) across the surface of the second scan mirror 206. In some embodiments, the scan mirror 206 oscillates along a second scan axis that is perpendicular to the first scan axis. Notably, in some embodiments, such as implementations using micro-LED display light, the optical scanner 220 is typically omitted.

The lightguide 212 of the laser projection system 200 includes the incoupler 210 and the outcoupler 214. In some embodiments, the lightguide 212 includes a combiner and uses total internal reflection (TIR) or a combination of TIR, specialized filters, and/or reflective surfaces, to transfer light from an incoupler to an outcoupler. For display applications, the light is a collimated image, for example, and the lightguide transfers and replicates the collimated image to the eye. In general, the terms “incoupler” and “outcoupler” will be understood to refer to any type of optical grating structure or reflective surface, including, but not limited to, diffraction gratings, slanted gratings, blazed gratings, holograms, holographic optical elements (e.g., optical elements using one or more holograms), volume diffraction gratings, volume holograms, surface relief diffraction gratings, and/or surface relief holograms. In some embodiments, the incoupler includes one or more facets, such as a Fresnel lens facet, and/or reflective or partially reflective surfaces. In some embodiments, a given incoupler or outcoupler is configured as a transmissive diffraction grating that causes the incoupler or outcoupler to transmit light and to apply designed optical function(s) to the light during the transmission. In some embodiments, a given incoupler or outcoupler is a reflective diffraction grating that causes the incoupler or outcoupler to reflect light and to apply designed optical function(s) to the light during the reflection. In the present example, the light 218 received at the incoupler 210 is relayed to the outcoupler 214 via the lightguide 212 using TIR. The light 218 is then output to the eye 216 of a user via the outcoupler 214. In some embodiments, the lightguide 212 is formed by a plurality of layers, e.g., a first substrate layer, a partition element layer, and a second substrate layer.

In some embodiments, incoupler 210 is a substantially rectangular feature configured to receive the light 218 and direct the light 218 into the lightguide 212. In some embodiments, the incoupler 210 is defined by a small dimension (i.e., width) and a long dimension (i.e., length). In an embodiment, the optical relay 208 is a line-scan optical relay that receives the light 218 scanned in a first dimension by the first scan mirror (e.g., the first dimension corresponding to the small dimension of the incoupler 210), routes the light 218 to the second scan mirror 206, and introduces a convergence to the light 218 in the first dimension. The second scan mirror 206 receives the converging light 218 and scans the light 218 in a second dimension, the second dimension corresponding to the long dimension of the incoupler 210 of the lightguide 212. The second scan mirror causes the light 218 to converge to a focal line along the second dimension. In some embodiments, the incoupler 210 is positioned at or near the focal line downstream from the second scan mirror 206 such that the second scan mirror 206 scans the light 218 as a line over the incoupler 210.

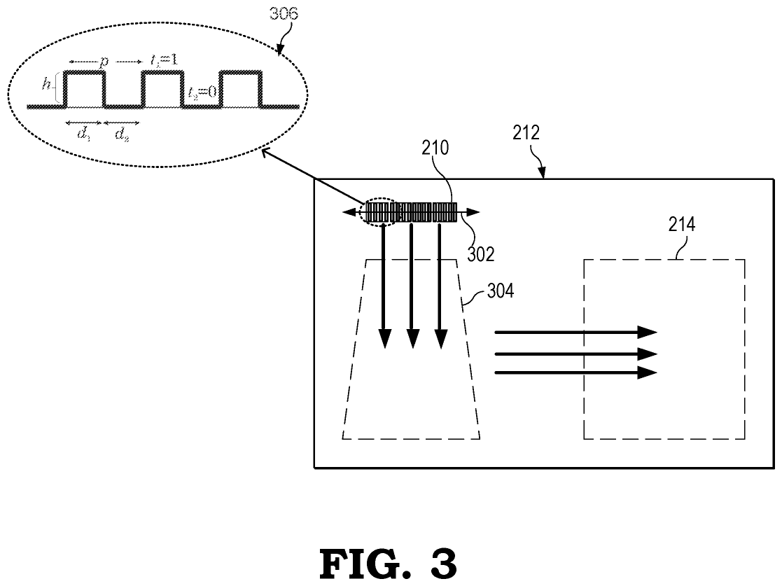

FIG. 3 shows an example of light propagation within the lightguide 212 of the projection system 200 of FIG. 2. As shown, light is received via incoupler (IC) 210, directed into an exit pupil expander (EPE) 304, and then routed to the outcoupler (OC) 214 to be output from the lightguide 212 (e.g., toward the eye of the user). In some embodiments, EPE 304 expands one or more dimensions of the eyebox of an eyewear display that includes the laser projection system 200 (e.g., with respect to what the dimensions of the eyebox of the eyewear display would be without the EPE 304). In some embodiments, the IC 210 and the EPE 304 each include respective one-dimensional diffraction gratings (i.e., diffraction gratings that extend along one dimension) or multi-dimensional diffraction gratings. It should be understood that FIG. 3 shows a substantially ideal case in which IC 210 directs light straight down (with respect to the presently illustrated view) in a first direction that is perpendicular to the scanning axis 302, and the EPE 304 directs light to the right (with respect to the presently illustrated view) in a second direction that is perpendicular to the first direction. While not shown in the present example, it should be understood that, in some embodiments, the first direction in which the IC 210 directs light is slightly or substantially diagonal, rather than exactly perpendicular, with respect to the scanning axis 302.

Also shown in FIG. 3 is a cross-section 306 of IC 210 illustrating features of the grating that can be configured to tune the efficiency of IC 210. The period p of the grating is shown having two regions, with transmittances t1=1 and t2=0 and widths d1 and d2, respectively. The grating period is constant p=d1+d2, but the relative widths d1, d2 of the two regions may vary. A fill factor parameter x can be defined such that d1=xp and d2=(1−x)p. In addition, while the profile shape of the grating features in cross-section 306 is generally shown as being square or rectangular with a height h, the shape can be modified based on the wavelength of light that IC 210 is intended to receive. For example, in some embodiments, the shape of the grating features is triangular, rather than square, to create a more “saw-toothed” profile. In some embodiments, IC 210 is configured as a grating with a constant period but different fill factors, heights, and slant angles based on the desired efficiency of the respective IC 210 or the desired efficiency of a region of the respective IC 210.

In some embodiments, the EPE 304 and the OC 214 are separated into or onto separate sections of a lightguide. For example, the IC 210 and the EPE 304 are located in or on a first section and the OC 214 is located in or on a second section, where a planar direction of the first section is substantially parallel to a planar direction of the second section. In some embodiments, the IC 210 and the EPE 304 are located in or on a first substrate and the OC 214 is located in or on a second substrate, where the first substrate and the second substrate are arranged adjacent to one another in the manners described herein.

In some embodiments, lightguide 212 includes multiple substrates with the EPE 304 located in or on a first substrate and the OC 214 located in or on a second substrate that is separate from and adjacent to the first substrate. In some embodiments, a partition element is placed in between the first substrate and the second substrate. For example, the partition element is an air gap (or other gas-filled gap), a low-index refractive material layer, a polarizing beam splitter layer, or any combination thereof. In some embodiments, the partition element includes additional elements or an opening to direct light from the first substrate to the second substrate.

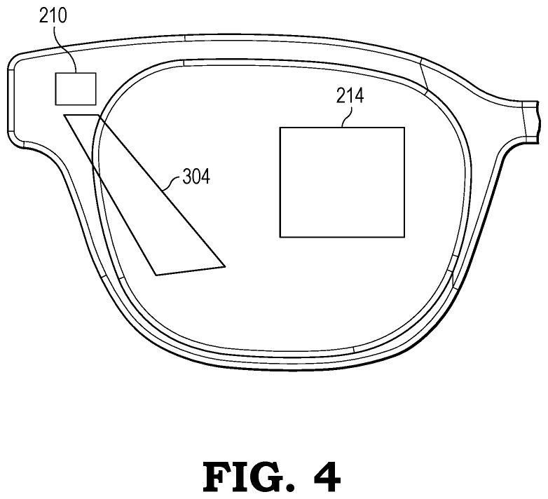

FIG. 4 shows an example of a portion of an eyewear display system with a limited FOV. As shown in FIG. 4, an ophthalmic lens-based eyewear display system generally provides a smaller FOV since there is a limited area available in the lens for one-dimensional (1D) gratings. For example, the FOV shown in FIG. 4 is in the range of about 10°×10°. In FIG. 4, the IC is in the temple area of the support structure. The EPE and OC are also illustrated in the lens area of eyewear display system.

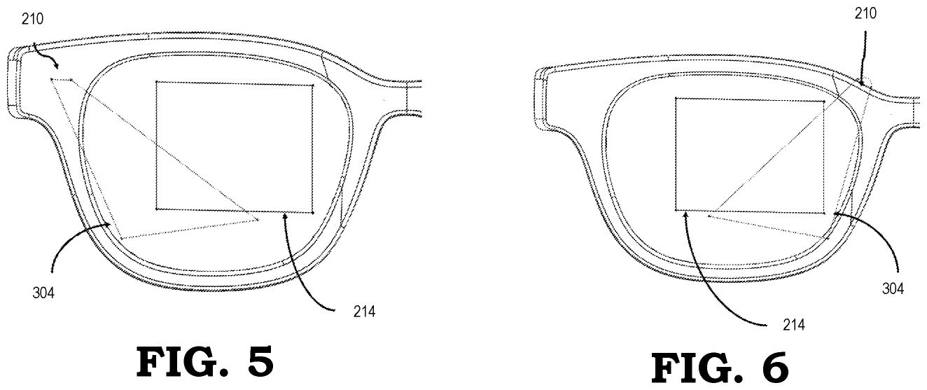

FIGS. 5 and 6 show examples of eyewear display systems with expanded FOVs. In FIG. 5, the IC is in the temple area of the support structure. In FIG. 6, the IC is in the nose bridge area of the support structure. In either case, a larger OC and a larger EPE are necessary to provide the expanded FOV. However, since a lens has limited space, problems may arise in providing the larger FOV by conventional means. Such a problem is illustrated by the interference (e.g., significant overlap) of the OC and EPE in FIGS. 5 and 6.

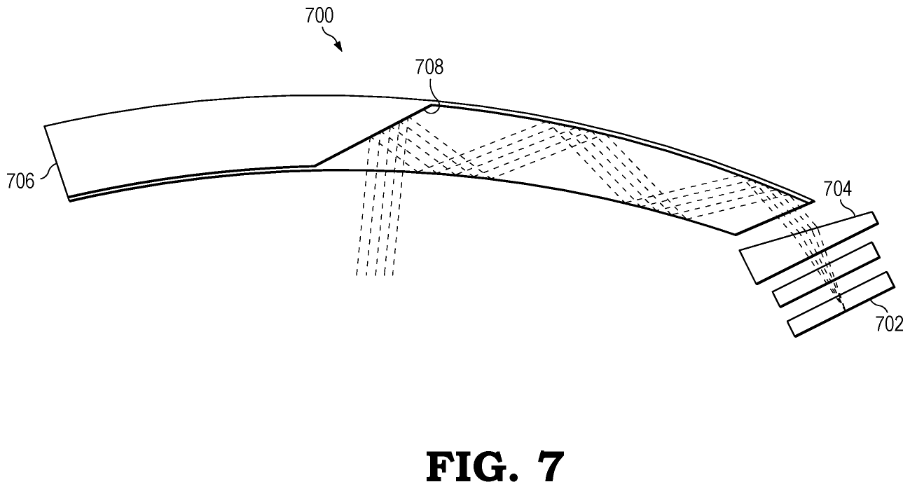

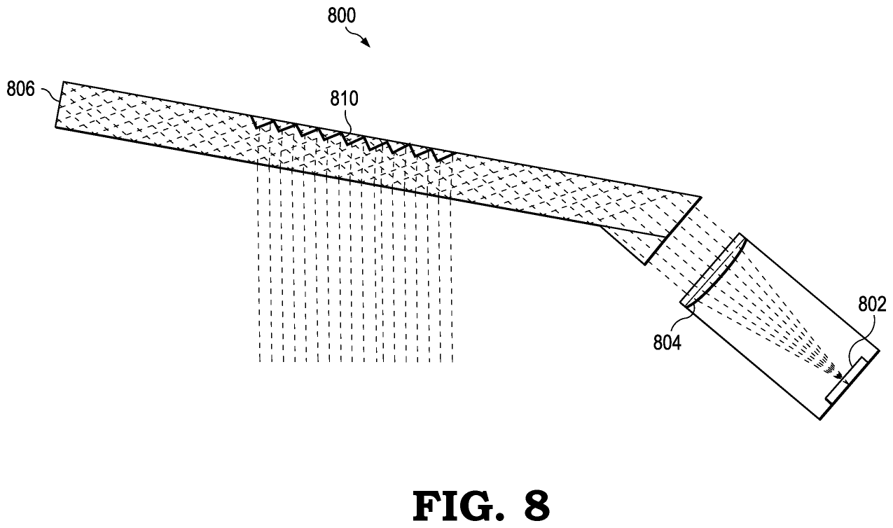

FIG. 7 shows an example of a curved lens display system 700 designed to implement a lens form factor similar to the form factor of a typical eyeglasses lens. The curved lens display system 700 includes a light source 702, a prism 704, and a lens 706 including a lightguide into which the light source 702 projects light for display. In order to outcouple the light transmitted through the lightguide of the lens 706 so that a user can view the intended display, a reflective or refractive optical feature, here reflective surface 708, is disposed within the lens. However, due primarily to the limitations of the thin, curved form factor, the effective eyebox size is limited. Accordingly, in some implementations, curved lens display systems like the curved lens display system 700 are only suitable for a relatively small subset of the population who can utilize the limited eyebox size without the display exhibiting undesirable levels of distortion or other image quality issues. Alternatively, a number of different curved lens displays like the curved lens display system 700 can be manufactured with varying eyebox locations in order to enable a wider range of the population to utilize the system 700. However, this requires designing and manufacturing several different variations of the curved lens display system 700, which increases manufacturing and inventory costs. One way to increase the size of the eyebox is to use a flat lens display system, as shown in FIG. 8.

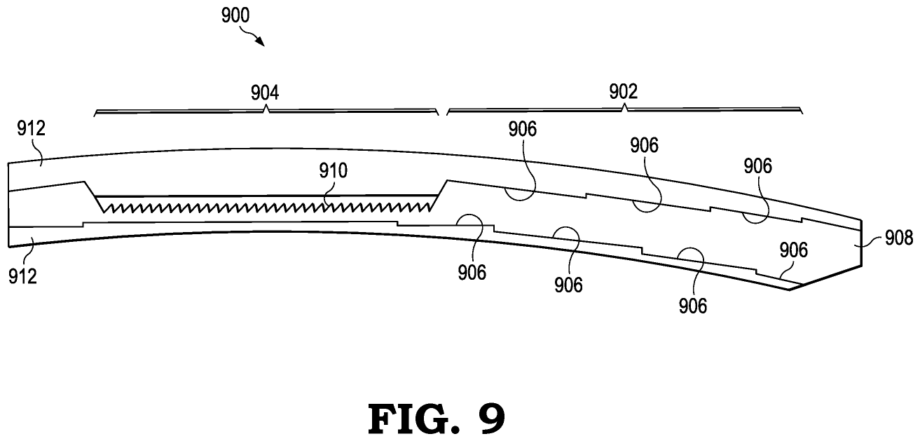

FIG. 8 shows an example of a flat lens display system 800 that can be used to implement a larger eyebox than the curved lens display system 700 of FIG. 7. The flat lens display system 800 includes a light source 802, a collimating lens 804, and a lens 806 including a lightguide into which the light source 802 projects light for display. After light from the light source 802 passes through the collimating lens 804, it is projected into the lightguide in the lens 806 and reflected into the eye of a user using reflective facets 810, which act as an EPE and provide a larger effective eyebox than the curved lens display system 700 of FIG. 7. However, the combination of the light source 802 and the collimating lens 804 requires a relatively large volume relative to the form factor of a typical pair of eyeglasses, which typically results in bulkier temple portions, bridge portions, or other portions in a wearable eyewear display. Additionally, the flat lens 806 has an appearance that differs from a curved lens in a typical pair of eyeglasses, which may be undesirable for some users. In order to resolve the various issues with the curved lens display system 700 of FIG. 7 and the flat lens display system 800 of FIG. 8, some embodiments implement a combination of a curved, collimating lightguide and a flat EPE region, as shown in FIGS. 9-11.

FIGS. 9-11 show examples and aspects of partially curved lightguides with pupil replicators in accordance with some embodiments. Creating a curved, injection moldable AR display with high efficiency and a large eyebox can require the use of diffractive pupil replication, which typically has very low efficiency. Other methods of pupil replication using reflective mirrors require flat lightguides, which can be difficult to incorporate, e.g., with ophthalmic lenses, into relatively thin form factors. To overcome these limitations, in some embodiments, as shown in FIGS. 9-11 and described further hereinbelow, three separate components are combined together to form a curved, high efficiency, transparent, and/or plastic moldable AR display.

FIG. 9 shows an example of a display system 900 including an embedded collimator with discontinuous surfaces in accordance with some embodiments. A curved, collimating lightguide 902 including a collimation region, located between a light source (not shown) and a pupil replication region of a flat EPE region 904 along a light propagation path in the display system 900, acts to collimate light from the light source for display. Subsequently, a flat EPE region 904 including a flat lightguide providing exit pupil replication and adjoined with the collimating lightguide 902 projects the light toward a user's eye and provides for a wider eyebox than typically would be possible in a curved lens display system like curved lens display system 700 of FIG. 7. In order to collimate the light, a number of discontinuous reflective surfaces 906 (e.g., discontinuous freeform surfaces) positioned along opposing sides of the length of the collimating lightguide 902 cause light entering the collimating lightguide 902 to reflect off of the discontinuous reflective surfaces 906 within a transmissive material 908 in such a way that the light is collimated into collimated display light by the time the light is projected onto a first surface of the flat EPE region 904.

Once collimated, the light passes through the EPE region 904 and is reflected (or, in some embodiments, refracted) by reflective facets 910 (and/or other optical elements, such as a diffractive grating, narrow-band holograms, diffractive lightguides, prisms, refractive replicators, a Bragg mirror, and/or a volumetric diffractive mirror) in order to provide pupil expansion and cause the light to exit or outcouple from the collimating lightguide 902 and propagate toward a user's eye. Notably, the transmissive material 908 and the reflective facets 910 are encased in other transmissive materials 912, such as glass or plastic, which provide an overall curved external form factor similar to a typical eyeglass lens. In some embodiments, the discontinuous reflective surfaces 906 are coated with low index coatings (e.g., chiolite), the reflective facets 910 are coated with a partial mirror, and/or the transmissive material 908 and other transmissive materials 912 are bonded using an adhesive with an index matched to the low index coatings to provide for TIR.

In some embodiments, rather than bonding the transmissive material 908 and other transmissive materials 912 using an adhesive with an index matched to low index coatings, spacer beads are utilized to create an air gap to provide for TIR prior to bonding. By minimizing the number of materials in the display system 900 (e.g., combining the transmissive material 908 and two other transmissive materials 912), the display system 900 is substantially monolithic when assembled, resulting in higher resiliency and better results in drop damage tests than conventional AR display systems.

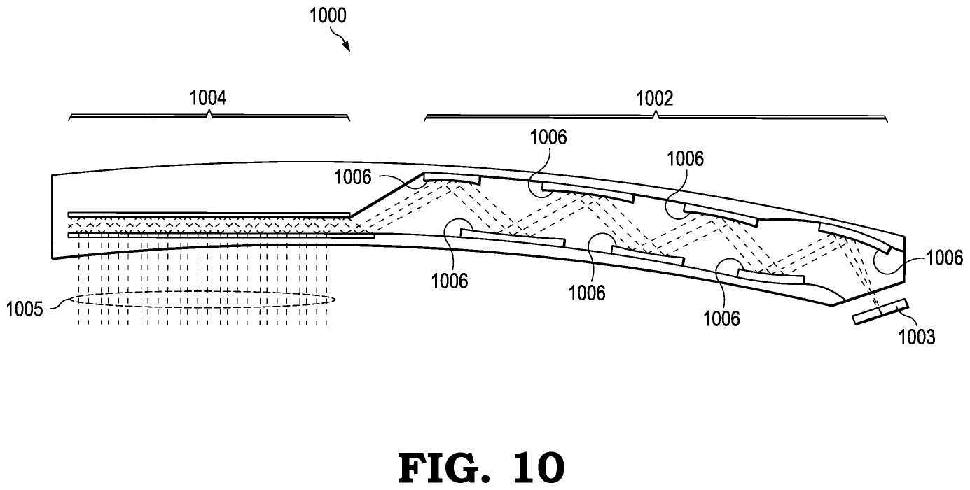

FIG. 10 shows an example of a display system 1000 including an embedded collimator with discontinuous surfaces in accordance with some embodiments. Similarly to FIG. 9, FIG. 10 illustrates a curved, collimating lightguide 1002 that acts to collimate light from a light source 1003 for display, while a flat EPE region 1004 provides for a wider eyebox 1005 than typically would be possible in a curved lens display system like curved lens display system 700 of FIG. 7. However, rather than using discontinuous reflective surfaces like the discontinuous reflective surfaces 906 of FIG. 9, the display system 1000 utilizes discontinuous reflective freeform surfaces 1006. By using discontinuous reflective freeform surfaces 1006, in some embodiments, image quality and tolerances are able to be optimized and tuned to ensure optimal image quality for a user of the display system 1000.

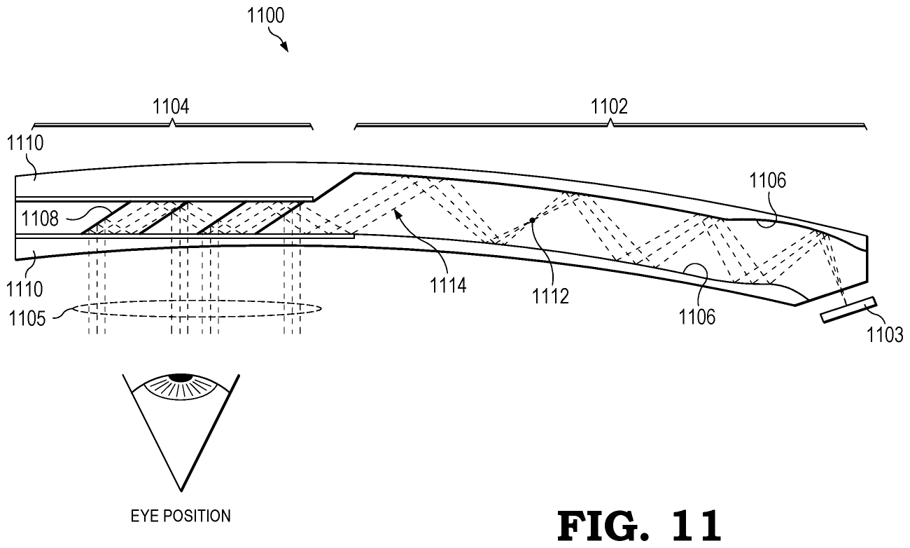

FIG. 11 shows an example of a display system 1100 including an embedded collimator with continuous surfaces in accordance with some embodiments. Like display system 1000 of FIG. 10, and similarly to FIG. 9, FIG. 11 illustrates a curved, collimating lightguide 1102 that acts to collimate light from a light source 1103 for display, while a flat EPE region 1104 provides for a wider eyebox 1105 than typically would be possible in a curved lens display system like curved lens display system 700 of FIG. 7. However, rather than using discontinuous reflective surfaces like the discontinuous reflective surfaces 906 of FIG. 9 or discontinuous reflective freeform surfaces like the discontinuous reflective freeform surfaces 1006 of FIG. 10, the display system 1100 utilizes reflective continuous freeform surfaces 1106. In some embodiments, the collimation region of the collimating lightguide 1102 includes a freeform surface extending substantially along a total length of the collimation region (e.g., at least 80% or more, or 90% or more, of a total physical length of the collimating lightguide 1102). By using continuous reflective freeform surfaces 1106, in some embodiments, image quality and tolerances are able to be optimized and tuned to ensure optimal image quality for a user of the display system 1100. Notably, although seven bounces are shown in FIG. 11 within the collimating lightguide before the light enters the flat EPE region 1104, in some embodiments, the curved lightguide provides for more (e.g., 20) or fewer bounces. In some embodiments, to prevent a particular bounce within the curved lightguide from causing problems with the AR display, the low index coating is omitted from the region of that bounce.

In some embodiments, costs of manufacturing and likelihood of manufacturing errors or defects are minimized by using continuous reflective freeform surfaces 1106. In addition to each opposing side of the collimating lightguide 1102 including only a single, continuous reflective freeform surface enabling tighter single-component tolerancing compared to implementations utilizing discontinuous reflective surfaces that each need to be configured and tolerance separately, this configuration also minimizes manufacturing errors and defects by reducing the number of separate surfaces that need to be placed within the collimating lightguide 1102. Notably, the collimating lightguide 1102 and facets 1108 are encased in other transmissive materials 1110, such as glass or plastic, which provide an overall curved form factor similar to a typical eyeglass lens. In some embodiments, the transmissive material 1110 includes a tinted substrate (e.g., sun-activated tinting) or coating and/or a prescription lens on an eye side and/or a world side of the collimating lightguide 1102 in order to provide functionality of sunglasses and/or prescription eyeglasses. In some embodiments, the light source 1103 is molded into a portion of the collimating lightguide 1102 and/or the other transmissive materials 1110 of the display system 1100. In some embodiments, the collimating lightguide 1102 produces a focused image 1112 prior to collimating the light and transmitting the collimated light 1114 into the flat EPE region 1104. In some embodiments, an outcoupler is configured to adjust a display accommodation distance. For example, in some embodiments, the outcoupler includes facets that are flat or curved to increase optical power. In other embodiments, the outcoupler includes diffractive gratings that act to increase or decrease optical power. When the curvature of a final lens in an AR display is large (e.g., larger than 1 diopter), some individuals find it difficult to focus on an image produced through such a lens. To account for this, the outcoupler is tuned (e.g., by modifying the curvature of the facets or the design of the grating) to provide an appropriate amount of optical power (e.g., to increase the optical power of the light for display) such that the light for display converges before reaching the external curved surface of the lens. In this way, the outcoupler is tuned to adjust a display accommodation distance.

In some embodiments, the flat EPE region 1104 includes a first flat, reflective surface on one side of the display system 1100 (e.g., the eye side) and a second flat, reflective surface on an opposing side of the display system (e.g., the world side). In some embodiments, one of the first and second flat, reflective surfaces of the EPE region 1104 extends closer to or further into the collimating lightguide 1102 than the other of the flat, reflective surfaces. As shown in FIG. 11, in some embodiments, by extending a portion of one of the flat, reflective surfaces of the EPE region 1104 (e.g., on the eye-side of the flat EPE region 1104), light such as the collimated light 1114 is projected onto a surface of the flat EPE region 1104 at a location where the flat, reflective surface extends. This enables light to be transmitted into the flat EPE region 1104 without requiring equal lengths of flat, reflective surfaces in the EPE region 1104, which minimizes manufacturing costs while enabling a smaller form factor for the display system 1100. In some embodiments, the continuous reflective freeform surfaces 1106 are produced by diamond turning a substrate.

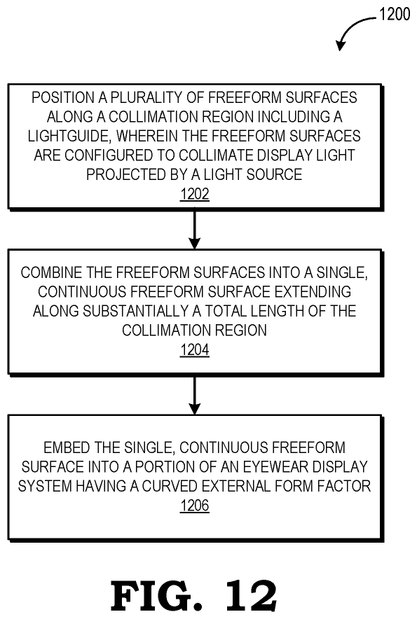

FIG. 12 illustrates an example method 1200 of manufacturing a collimation region for an eyewear display system. At block 1202, method 1200 begins with positioning a plurality of discontinuous freeform surfaces, such as discontinuous reflective surfaces 906 of FIG. 9 or discontinuous reflective freeform surfaces 1006 of FIG. 10, along a collimation region including a lightguide, such as the collimation region of the collimating lightguide 902 of FIG. 9 or the collimation region of the collimating lightguide 1002 of FIG. 10, wherein the freeform surfaces are configured to collimate display light projected by a light source. At block 1204, the freeform surfaces are combined into a single, continuous freeform surface, like continuous reflective freeform surfaces 1106 of FIG. 11, extending along substantially a total length of the collimation region and/or the collimating lightguide. In some embodiments, the combination of the surfaces is achieved by specifying constraints on a merit function and/or boundary conditions of the surfaces themselves in optical design software to produce a single freeform software and/or mathematical description for the single, continuous freeform surface. At block 1206, the single, continuous freeform surface is embedded into a portion of an eyewear display system having a curved external form factor.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An eyewear display system comprising:
a curved lightguide; and
a flat lightguide adjoined with the curved lightguide, the flat lightguide providing exit pupil replication.

2. The eyewear display system of claim 1, wherein the curved lightguide comprises a collimation region located between a light source and a pupil replication region along a light propagation path.

3. The eyewear display system of claim 2, wherein the collimation region is configured to collimate display light projected by the light source such that the display light is collimated when transmitted onto a surface of the pupil replication region.

4. The eyewear display system of claim 2, wherein the collimation region is configured to focus the display light at least once along the light propagation path.

5. The eyewear display system of claim 2, wherein the collimation region includes a first freeform surface extending substantially along a total length of the collimation region.

6. The eyewear display system of claim 1, further comprising a tinted substrate.

7. The eyewear display system of claim 1, further comprising an outcoupler configured to adjust a display accommodation distance.

8. An eyewear display system comprising:
a light source; and
a lightguide comprising:
a pupil replication region; and
a collimation region located between the light source and the pupil replication region along a light propagation path, wherein the collimation region is configured to collimate display light projected by the light source.

9. The eyewear display system of claim 8, wherein the collimation region is configured to project the display light onto a surface in the pupil replication region.

10. The eyewear display system of claim 9, wherein the collimation region is configured to provide the collimated display light onto the surface of the pupil replication region.

11. The eyewear display system of claim 8, wherein the collimation region is configured to focus the display light at least once along the light propagation path.

12. The eyewear display system of claim 8, wherein the collimation region includes a first freeform surface extending substantially along a total length of the collimation region.

13. The eyewear display system of claim 8, wherein the collimation region is located in a portion of the eyewear display system having a curved external form factor.

14. The eyewear display system of claim 13, wherein the pupil replication region includes a flat lightguide.

15. The eyewear display system of claim 13, wherein the pupil replication region is in a portion of the eyewear display system having a curved external form factor.

16. A method of manufacturing a collimation region for an eyewear display system, comprising:
positioning a plurality of freeform surfaces along a collimation region including a lightguide, wherein the freeform surfaces are configured to collimate display light projected by a light source.

17. The method of claim 16, wherein the freeform surfaces are discontinuous freeform surfaces, the method further comprising combining the freeform surfaces into a single, continuous freeform surface extending along substantially a total length of the collimation region.

18. The method of claim 17, further comprising diamond turning a substrate to produce the single, continuous freeform surface.

19. The method of claim 18, further comprising embedding the single, continuous freeform surface into a portion of an eyewear display system having a curved external form factor.

20. The method of claim 16, further comprising configuring the freeform surfaces to reflect the display light by total internal reflection.
